(19) United States
(12) Patent Application Publication
(10) Pub. No.: US 2025/0386149 A1
(43) Pub. Date: Dec. 18, 2025

(54) ACOUSTIC ELEMENT, ACOUSTIC DEVICE, AND PREPARATION METHOD FOR ACOUSTIC ELEMENT

(71) Applicant: Shanghai United Imaging Microelectronics Technology Co., Ltd., Shanghai (CN)

(72) Inventors: Yinze Xiong, Shanghai (CN); Fa Wang, Shanghai (CN)

(21) Appl. No.: 18/875,173

(22) PCT Filed: Jun. 15, 2023
(86) PCT No.: PCT/CN2023/100473

§ 371 Date: Dec. 16, 2024

(30) Foreign Application Priority Data
Jun. 17, 2022 (CN) 202210688295.0

(51) Int. Cl. H04R 25/00; H04R 1/10

(52) U.S. Cl. CPC H04R 25/456; H04R 1/1016; H04R 25/48; H04R 25/652; H04R 25/658; H04R 2225/77; H04R 2460/09; H04R 2460/11

(57) ABSTRACT

An acoustic element, an acoustic device, and a preparation method for the acoustic element are provided. The acoustic element is used to hold a first audio apparatus in a user's ear canal. The acoustic element includes: a first end suitable for being located near the inner side of an ear, a second end suitable for being located near the outer side of the ear, and a porous structure provided between the first end and the second end, wherein a plurality of first holes communicated with each other are defined inside the porous structure, and the first end and the second end are communicated by means of at least some of the first holes; and an accommodating cavity used for at least partially accommodating the first audio apparatus, the accommodating cavity being communicated with the outside from the first end of the acoustic element.

The present disclosure claims priority of Chinese Patent Application No. 202210688295.0, filed on Jun. 17, 2022, and entitled “ACOUSTIC ELEMENT, ACOUSTIC DEVICE AND METHOD FOR MANUFACTURING AN ACOUSTIC ELEMENT”, the entire content of which is incorporated herein by reference in its entirety.

### TECHNICAL FIELD

The present disclosure relates to the technical field of acoustic devices, and in particular to an acoustic element, an acoustic device, and a method for manufacturing an acoustic element.

### BACKGROUND

Ear mold is a very important acoustic element in acoustic device, which can fix a speaker or receiver in a user's ear canal, while moderately insulating the external sound to improve the acoustic characteristics received by a user. However, after wearing the ear mold, an external ear canal of the user will be closed to an external environment, a sound pressure of a low-frequency part of user's own voice will increase in a cavity formed between the ear canal and the ear mold, so that an echo can be heard, that is, an occlusion effect occurs, which affects the user's experience.

In order to solve the occlusion effect, in the related art, a ventilation channel is provided in the ear mold, so that the ear canal can transmit air flow with the external environment outside through the ventilation channel, thereby reducing the occlusion effect. Generally, the occlusion effect decreases with the increase of a hole diameter of the ventilation channel. However, an excessive hole diameter of the ventilation channel will lead to acoustic noise by acoustic feedback. Therefore, the hole diameter of the ventilation channel needs to be controlled within an appropriate range, but it is difficult to design the ventilation channel with an appropriate hole diameter.

### SUMMARY

Based on this, it is necessary to provide an acoustic element, an acoustic device, and a method for manufacturing an acoustic element.

In a first aspect, an acoustic element is provided. The acoustic element includes a first end adapted to be located proximate to inside of an ear, a second end adapted to be located proximate to outside of the ear, and a porous structure provided between the first end and the second end. The porous structure is provided with a plurality of first holes in communication with each other and an accommodating cavity. The first end is in communication with the second end through at least part of the first holes. The accommodating cavity is configured to at least partially accommodate a first audio device. The accommodating cavity is in communication with an external environment from the first end.

In some embodiments, at least part of the plurality of first holes in communication with each other form a mesh channel, and the first end is in communication with the second end through the mesh channel.

In some embodiments, the porous structure is a three-dimensional frame structure, the three-dimensional frame structure includes a plurality of repeating units, the plurality of repeating units are arranged in an array in a three-dimensional space, and the plurality of first holes are formed between the plurality of repeating units.

In some embodiments, each repeating unit includes at least three rods respectively extend in non-coplanar directions, and ends of adjacent rods of the plurality of repeating units are connected to each other.

In some embodiments, a longitudinal dimension of each rod is from 100 microns to 5 millimeters, preferably from 1 millimeter to 2 millimeters, and a transverse dimension of each rod is from 20 microns to 1 millimeter, preferably from 200 microns to 400 microns.

In some embodiments, the plurality of repeating units are formed of a porous material having a plurality of second holes.

In some embodiments, hole diameters of the plurality of second holes are less than or equal to 50 microns, preferably from 10 nanometers to 1 micron.

In some embodiments, a porosity of the porous structure is less than or equal to 99%, preferably from 1% to 95%, more preferably from 60% to 95%, and still more preferably from 75% to 95%.

In some embodiments, a porosity of the porous structure gradually decreases in a direction from the first end to the second end.

In some embodiments, hole diameters of the plurality of first holes are from 100 microns to 5 millimeters, preferably from 1 millimeter to 2 millimeters.

In some embodiments, the acoustic element further includes an outer housing, the porous structure is at least partially provided in the outer housing, the housing has a first opening at the first end and a second opening at the second end, the porous structure is exposed from the first opening and the second opening.

In some embodiments, the housing and/or the porous structure are elastic.

In some embodiments, a size of at least a portion of the housing is adapted to a user's ear canal.

In some embodiments, the acoustic element further includes a fixing structure, the fixing structure cooperates with a pinna of a user and is connected to the housing to fix the acoustic element to the ear of the user.

In some embodiments, the porous structure is further provided with an acoustic hole, the acoustic hole is provided between the accommodating cavity and the first end, and the accommodating cavity is in communication with the external environment through the acoustic hole.

In some embodiments, the acoustic element is an intra-aural ear mold.

In a second aspect, an acoustic device is provided, including the aforementioned acoustic element and a first audio device being at least partially accommodated in an accommodating cavity.

In some embodiments, the acoustic device further includes a second audio device communicatively connected to the first audio device.

In some embodiments, the second audio device is a hearing aid.

In some embodiments, the second audio device communicates with the first audio device though a wireless network or a signal line.

According to a third aspect, the present disclosure provides a method for manufacturing the aforementioned acoustic element, the method includes:

acquiring fitting data of a user, the fitting data including user ear size information and/or acoustic device information; and

selecting or manufacturing an acoustic element corresponding to a user according to the fitting data.

In some embodiments, the user ear size information includes critical size data, the acoustic device information includes user audio impairment data, and the selecting an acoustic element corresponding to the user according to the fitting data includes:

determining a plurality of size-matched standard acoustic elements from a plurality of standardized acoustic elements according to the user ear size information;

determining a power required by an acoustic device according to the acoustic device information; and

selecting a power-matched target standard acoustic element from the plurality of size-matched standard acoustic elements.

In some embodiments, the user ear size information includes user ear canal modeling data, the acoustic device information includes user audio impairment data, and the manufacturing an acoustic element corresponding to the user according to the fitting data includes:

designing a contour of the acoustic element corresponding to the user according to the user ear size information;

determining a power required by the acoustic device according to the acoustic device information; and

manufacturing the acoustic element corresponding to the user according to the contour and the power required by the acoustic device.

### BRIEF DESCRIPTION OF THE DRAWINGS

In order to illustrate the embodiments of the present disclosure or the technical solutions in the conventional art more clearly, the drawings used in the embodiments or the conventional art will be described briefly. Apparently, the following described drawings are merely for the embodiments of the present disclosure, and other drawings can be derived by those of ordinary skill in the art without any creative effort.

FIG. 1 is a perspective view of an acoustic element according to an embodiment of the present disclosure.

FIG. 2 is a cross-sectional view of an acoustic element according to an embodiment of the present disclosure.

FIG. 3 is a partial enlarged view of a porous structure according to an embodiment of the present disclosure.

FIG. 4 is an optical photograph of a porous structure according to an embodiment of the present disclosure.

FIG. 5 is a perspective view of a porous structure having a hole diameter gradually changes according to another embodiment of the present disclosure.

FIG. 6 is a partial enlarged view of a porous structure according to an embodiment of the present disclosure, which is enlarged twice.

FIG. 7 is a perspective view of acoustic elements of different sizes according to some embodiments of the present disclosure.

FIGS. 8A to 8F are perspective views of an acoustic element including a fixing structure according to some embodiments of the present disclosure.

FIG. 9 is a schematic view of an acoustic device according to an embodiment of the present disclosure.

FIG. 10 is a flowchart of a method for manufacturing an acoustic element according to an embodiment of the present disclosure.

### DETAILED DESCRIPTION OF THE EMBODIMENTS

The technical solution in the embodiment of the present disclosure will be clearly and completely described below in conjunction with the drawings in the embodiment of the present disclosure. Apparently, the described embodiments are only some of the embodiments of the present disclosure, not all of them. Based on the embodiments in the present disclosure, all other embodiments obtained by a person skilled in the art without making creative efforts shall all fall within the protection scope of the present disclosure.

As an important acoustic element, an ear mold can fix a speaker or receiver in a user's ear canal, while moderately insulating the external sound to improve the acoustic characteristics. The ear mold is usually customized according to shapes of an auricular concha cavity and an external auditory canal of a wearer. According to the materials used, the ear mold can be divided into a hard ear mold represented by the acrylic material ear mold and a soft ear mold represented by the silicone material ear mold. After wearing the ear mold, an external ear canal of the user will be closed to an external environment, and a cavity formed by the ear mold and the ear canal will amplify a low frequency part of user's own voice and cause the bone conduction hearing threshold level to be decreased, so that the user feels that the voice is stuffy and hollow, like speaking in a bucket, so that the user feels uncomfortable, that is, an “occlusion effect” occurs. In the related art, the occlusion effect is mitigated by providing a ventilation channel in the ear mold or reducing the low frequency gain. The occlusion effect decreases with the increase of a hole diameter of the ventilation channel, but the excessive ventilation channel will cause acoustic feedback to a microphone outside the ear and cause acoustic noise, which reduces the user's experience.

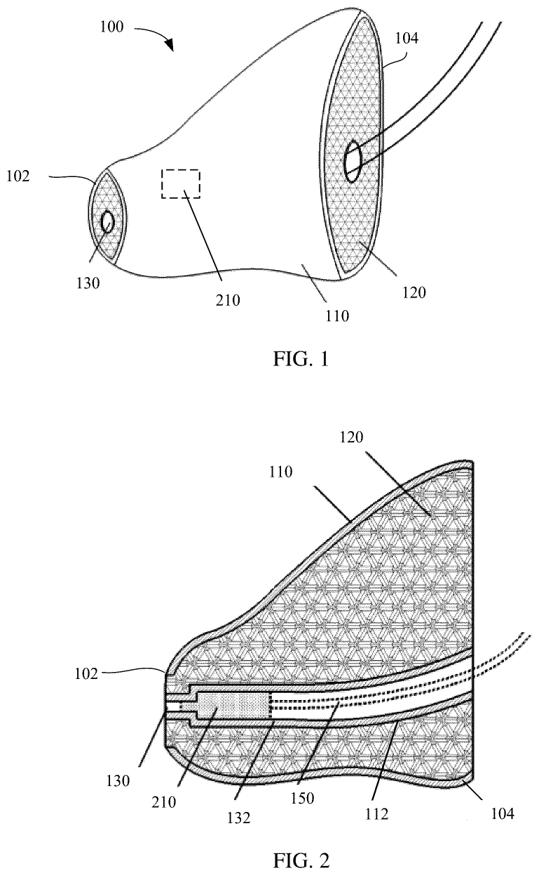

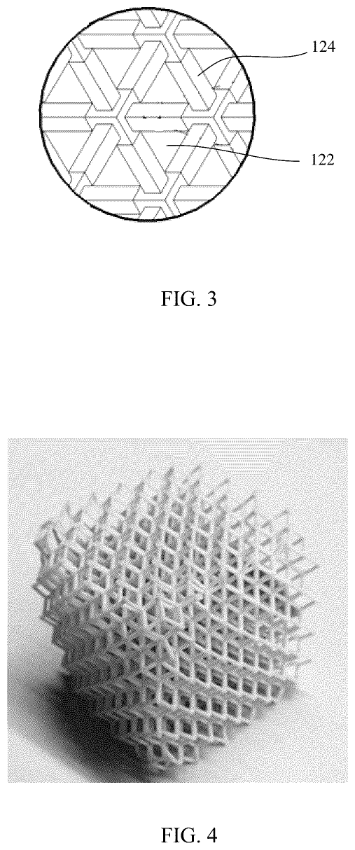

Referring to FIGS. 1 to 3, according to an embodiment of the present disclosure, an acoustic element 100 is provided for retaining a first audio device 210 in a user's ear canal (or external ear canal). The acoustic element 100 includes a first end adapted to be located proximate to inside of an ear and a second end adapted to be located proximate to outside of the ear, and includes a porous structure 120 provided between the first end and the second end. The porous structure 120 is provided with a plurality of first holes 122 in communication with each other and an accommodating cavity 132 configured to at least partially accommodate the first audio device 210. The first end of the acoustic element 100 is in communication with the second end of the acoustic element 100 through at least part of the first holes 122. The accommodating cavity 132 is in communication with an external environment from the first end of the acoustic element 100.

According to the acoustic element 100, the air inside and outside the ear canal can be circulated through the plurality of first holes 122 of the porous structure 120 in communication with each other, thereby balancing the pressure inside and outside the ear canal and improving the occlusion effect. In addition, the plurality of first holes 122 are connected to each other to form a mesh channel extending meanderingly, which facilitates sound absorption, thereby effectively reducing acoustic noise and improving the wearing experience of the user.

In some embodiments, a radial dimension of the first end of the acoustic element 100 may be less than a radial dimension of the second end of the acoustic element 100, for example, a size of the first end is adapted to the user's ear canal, so that the first end is adapted to be adjacent to the inside of the ear and the second end is larger and adapted to be adjacent to the outside of the ear. In some embodiments, the acoustic element 100 is deformable, for example elastic, and the size of the acoustic element 100 may not be adapted to the user's ear, thereby being more universal. In some embodiments, the first end and the second end may have the same size, e.g., slightly greater than a size of a typical human ear canal, and the first end can be provided in the user's ear canal by reducing the size when stressed and compressed.

In some embodiments, the acoustic element 100 further includes an outer housing 110. The porous structure 120 is at least partially provided in the outer housing 110. At least a portion of the outer housing 110 has a size adapted to the user's ear canal and is adapted to directly attached to the user's ear canal. The outer housing 110 is configured to protect the porous structure 120 against wear of the porous structure 120 or entry of debris (such as cerumen or dust) into the porous structure 120. The material of the outer housing 110 may be a polymer material, such as plastic, rubber, or resin. In some embodiments, the outer housing 110 may be a material that has good biocompatibility and can be deformed by force, such as a material having good elasticity, such as thermoplastic polyurethane elastomer (TPU), thermoplastic elastomer (TPE), elastic polyurethane (EPU), silicone, etc.

In other embodiments, at least a portion of the porous structure 120 is adapted to directly attached to the user's ear canal without being accommodated in the outer housing 110.

In the embodiment, the acoustic element 100 may be an ear mold. According to the difference between the user's left and right ear canals, the acoustic elements 100 suitable for the left ear canal and the right ear canal may have different shapes to adapted to left ear canal and the right ear canal. Accordingly, the outer housing 110 may have a shape adapted to the ear canal. In some embodiments, the acoustic element 100 as a whole is deformable, the outer housing 110 is also deformable, and may have a shape that is not adapted to the ear canal when not subjected to external forces. In some embodiments, the shape of the outer housing 110 may be a cylindrical shape, etc., with a cross-sectional area that gradually increases from inside to outside of the ear, which is not specifically limited herein.

In some embodiments, the outer housing 110 has a first opening 102 at the first end of the acoustic element 100 and a second opening 104 at the second end of the acoustic element 100. The porous structure 120 is exposed from the first opening 102 and the second opening 104. When a signal is transmitted to the first audio device 210 in a wired manner, a signal communication line 150 is inserted into the acoustic element 100 through the second opening 104, and is connected to the first audio device 210 accommodated in the accommodating cavity 132. The sizes of the first opening 102 and the second opening 104 can be same or different, which are not specifically limited herein.

The first audio device 210 is configured to emit sound waves, for example, it may be a device that converts an audio electrical signal into a sound signal, such as a speaker or receiver, or a device that transmits sound waves, so as to directly transmit external sound waves into the ear canal. In some embodiments, a size of the accommodating cavity 132 is adapted to the first audio device 210, so as to at least partially accommodate and fix the first audio device 210. Specifically, the accommodating cavity 132 may be provided at the center of the porous structure 120, and the accommodating cavity 132 is exposed from the first end of the acoustic element 100, so that sound waves emitted from the first audio device 210 can be transmitted into the user's ear canal. When the acoustic element 100 has the outer housing 110, the first audio device 210 is provided in the outer housing 110. In some embodiments, the porous structure 120 may further have a wiring channel configured to allow the signal communication line 150 to extend therethrough from the second end to be connected to the first audio device 210 accommodated in the accommodating cavity 132. In some embodiments, the first audio device 210 is wirelessly connected to an external device, and the porous structure 120 may not have a wiring channel.

In some embodiments, the porous structure 120 is further provided with acoustic holes 130. The acoustic hole 130 is provided between the accommodating cavity 132 and the first end of the acoustic element 100, and the accommodating cavity 132 is in communication with the external environment through the acoustic hole 130. When the acoustic element 100 has the outer housing 110, the acoustic hole 130 is provided in the outer housing 110 and is exposed to the outside from the first opening 102 of the outer housing 110. It should be understood that when the acoustic element 100 has the acoustic hole 130, the first audio device 210 is spaced from the first end of the acoustic element 100 through the acoustic hole 130. When the acoustic element 100 does not have an acoustic hole 130, the end of the first audio device 210 configured to emit sound waves may be coplanar with the first end of the acoustic element 100, so that sound is transmitted from the first end of the acoustic element 100 into the user's ear canal.

In some embodiments, the porous structure 120 is a three-dimensional frame structure. The plurality of first holes 122 are defined by the three-dimensional frame structure. Specifically, the three-dimensional frame structure may include a plurality of repeating units. The plurality of repeating units have substantially the same shape and are arranged in an array in a three-dimensional space, and the plurality of first holes 122 are formed between the plurality of repeating units.

Referring to FIG. 4, in some embodiments, each repeating unit includes at least three rods 124, and the rods 124 respectively extend in different directions, so that at least one rod 124 in each repeating unit is provided in a different plane from the other rods 124, that is, at least one rod 124 in each repeating unit is not coplanar with the other rods 124. Ends of adjacent rods 124 of the plurality of repeating units arranged in an array in the three-dimensional space are connected to each other to form a three-dimensional frame structure. The three-dimensional frame structure formed by the plurality of repeating units can be obtained by 3D printing, and a method of 3D printing (also referred to as additive manufacturing) may be, for example, digital light processing (DLP), fused deposition modeling (FDM), selective laser sintering (SLS), direct write ink writing (DIW), or inkjet 3D printing (3DP), etc.

Specifically, each first hole 122 is enclosed by adjacent rods 124 connected at the ends thereof. The shape of the first hole 122 is determined by the number of rods 124 that enclose the first hole 122. The first hole 122 may be any polygon, such as, but not limited to, a triangle, a rectangle, a pentagon, a hexagonal, or an octagon. The angles between plurality of the rods 124 of the same repeating unit may be the same or different, and the lengths of the rods 124 may also be the same or different. The cross-sectional shape of the rod 124 is not limited and may be, for example, a circle or a polygon, such as a triangle, rectangle, pentagon, hexagonal or octagon.

In an embodiment, each repeating unit has three rods 124, and the angles between adjacent rods 124 are all 90 degrees. The first hole 122 is a rectangular hole. In an embodiment, each repeating unit has four rods 124, and the angles therebetween are all about 109 degrees. The first hole 122 is a regular hexagonal hole. In an embodiment, each repeating unit has six rods 124, and the angles therebetween are all 60 degrees. The first hole 122 is a triangular hole and a hexagonal hole.

In some embodiments, a longitudinal dimension, such as length, of each rod 124 is from 100 microns to 5 millimeters, e.g., from 1 millimeter to 2 millimeters. In some embodiments, a transverse dimension, such as a diameter, of each rod 124 is from 20 microns to 1 millimeter, e.g., from 200 microns to 400 microns.

In some embodiments, the hole diameter of each of the plurality of first holes 122 is from 100 microns to 5 millimeters, e.g., from 1 millimeter to 2 millimeters. Since the three-dimensional frame structure is composed of a plurality of repeating units, and the repeating units have substantially the same shape, the plurality of first holes 122 of the porous structure 120 may have a substantially regular arrangement pattern, size distribution and shape, which is different from irregular holes randomly distributed.

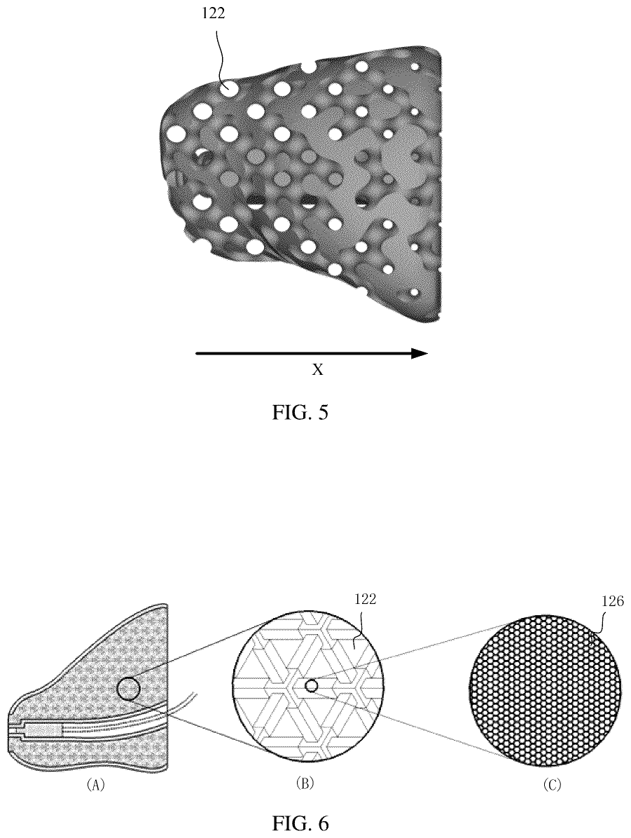

In some embodiments, an overall porosity of the porous structure 120 in a range of no more than 99%, e.g., from 1% to 95%, in some embodiments, from 60% to 95%, and further e.g., from 75% to 95%. Referring to FIG. 5, in some embodiments, the porosity of the porous structure 120 gradually decreases in a direction from the first end to the second end (a direction X in FIG. 5). Specifically, the sizes of the plurality of first holes 122 of the porous structure 120 gradually decrease in a direction from the first end to the second end, such that the damping of the fluid can be increased without affecting the overall porosity of the porous structure 120, which is more conducive to the attenuation of the sound emitted from the first audio device 210 toward the outside of the ear canal, and also to prevent the external ambient sound from entering the ear canal. The acoustic element 100 has a greater porosity at the first end to better reduce the occlusion effect, and a smaller porosity at the second end to better avoid the acoustic noise caused by the acoustic feedback. Moreover, when the acoustic element 100 is elastic and has a size slightly larger than the user's ear canal, the first end is compressed to a certain extent when provided in the ear canal, so that the first hole 122 adjacent to the first end is compressed and reduced in size. The first hole 122 adjacent to the first end has a larger size so that the first hole 122 may not be completely closed after being compressed, so that the first hole 122 adjacent to the first end can be in communication with the first hole 122 adjacent to the second end more reliably, and the overall permeability of the acoustic element 100 is maintained. In other embodiments, the porosity of the porous structure 120 remains constant in the direction from the first end to the second end, for example, the plurality of first pores 122 of the porous structure 120 have the same size, and such porous structure 120 is easier to manufacture and has a lower cost.

Corresponding to the size of the first hole 122, sizes of the plurality of repeating units having the same shape may be the same or different. In some embodiments, the sizes of the plurality of repeating units gradually decrease in the direction from the first end to the second end, for example, the sizes of the repeating units in different directions gradually decrease in the same proportion. In other embodiments, the plurality of repeating units constituting the three-dimensional frame structure have the same size.

In some embodiments, at least part of the plurality of first holes 122 in communication with each other form a mesh channel independent of the accommodating cavity 132, and the first end of the acoustic element 100 is in communication with the second end of the acoustic element 100 through the mesh channel. That is, even if the first audio device 210 completely blocks the accommodating cavity 132 to form a fluid isolation, the inside of the ear canal may be in fluid communication with the outside through the mesh channel formed by the plurality of first holes 122, so as to avoid the occlusion effect. Since the mesh channel in the porous structure 120 extends meanderingly in the three-dimensional space, the sound propagating through the acoustic element 100 to the outside of the ear canal can be attenuated, and the possibility of acoustic noise is greatly reduced. In addition, since the size of the first hole 122 is relatively large, for example, it can reach the millimeter level, so that the acoustic element 100 has better air permeability, which is conducive to keeping the user's ear dry, and avoids ear canal inflammation caused by moisture in the ear canal due to long-term wearing.

Since the porous structure 120 is provided with a plurality of first holes 122, a ventilation channel does not need to be designed separately according to data such as the user's hearing curve, so that the time required for designing the ventilation channel is saved, and thus the manufacturing efficiency of the acoustic element 100 can be improved. In addition, the sizes of the plurality of first holes 122 of the porous structure 120 may not all be the same, and the difficulty in designing the porous structure 120 may be reduced, thereby improving the manufacturing efficiency of the porous structure 120 and further improving the manufacturing efficiency of the acoustic element 100.

In some embodiments, the porous structure 120 is made of a polymer material. Specifically, the rod 124 of the repeating unit of the three-dimensional frame structure may be made of the aforementioned polymer material. The polymer material may be, for example, plastic, rubber, or resin. In some embodiments, the polymer material may be a material that has good biocompatibility and can be deformed under the action of force, for example, a material having good elasticity, such as a thermoplastic polyurethane (TPU), a thermoplastic elastomer (TPE), an elastic polyurethane (EPU), and silicone, etc. The porous structure 120 and the housing may be made of the same material. Due to the plurality of first holes 122, the porous structure 120 can be more flexible on the basis of the elasticity of the polymer material itself, for example, the porous structure 120 has a lower elastic modulus and shore hardness, and a higher compressive fracture strain.

Referring to FIG. 6, in some embodiments, the porous structure 120 is made of a porous material, such as an aerogel material, such that the material itself has a large number of micropores, i.e., the second holes 126. The second hole 126 is smaller in size than the first hole 122. In some embodiments, sizes of the second holes 126 are less than or equal to 50 microns, such as from 10 nanometers to 1 micron. Specifically, the rod 124 of the repeating unit of the three-dimensional frame structure is formed of a porous material having a plurality of second holes 126. It should be understood that, unlike the first holes 122, which have a basic regular arrangement, a regular size distribution and a regular shape, the micropores of the aerogel material are randomly distributed in an out-of-order manner, and the size and the shape are irregular, so that the sound can be further effectively absorbed and the acoustic noise phenomenon can be reduced. However, the micropores of the aerogel material are not necessarily in communication with each other, thus the permeability of the acoustic element 100 is mainly achieved by the first holes 122 in communication with each other. In the embodiment, the porous structure 120 has multi-level holes, which include the first holes 122 in communication with each other formed between the repeating units arranged in a three-dimensional array, and the second hole 126 formed in the material itself forming the repeating unit, so that the acoustic element 100 has a better sound attenuation effect, the sound transmitted from the first audio device 210 to the outside of the ear canal can be further attenuated, and anti-acoustic noise effect is enhanced, so as to be suitable for the first audio device 210 to emit a higher power sound. The porous structure 120 having multi-level holes can be obtained by, for example, 3D printing. Specifically, the porous structure 120 can be obtained by 3D printing a three-dimensional frame structure using an aerogel precursor material, and then performing a supercritical drying treatment on the three-dimensional frame structure. The method of 3D printing (also referred to as additive manufacturing) may be, for example, digital light processing (DLP), fused deposition modeling (FDM), selective laser sintering (SLS), direct ink writing (DIW), or inkjet 3D printing (3DP), etc.

In some embodiments, the acoustic element 100 further includes an inner housing 112 provided on a sidewall of the acoustic hole 130 and/or the accommodating cavity 132. The porous structure 120 is provided between the inner housing 112 and the outer housing 110. The inner housing 112 separates the first audio device 210 and the signal communication line 150 from the porous structure 120, and protects the porous structure 120 from the inside to avoid wear. Since both ends of the acoustic element 100 are in communication with each other through the porous structure 120, both the inner housing 112 and the outer housing 110 may be formed of a continuous gas-tight material without being in communication with the porous structure 120. The first audio device 210 in the inner housing 112 may completely block the accommodating cavity 132, so that both sides of the first audio device 210 are fluidly isolated. The material of the inner housing 112 may be the same as that of the outer housing 110. In some embodiments, the inner housing 112 may be formed of a hard material to provide support for protecting the first audio device 210 and the signal communication line 150. The inner housing 112, the outer housing 110 and the porous structure 120 of the acoustic element 100 may be formed by 3D printing once, or may be separately manufactured and then assembled together.

In some embodiments, the outer housing 110 and the porous structure 120 are both deformable, so that the entire acoustic element 100 as a whole is deformable. Deformable means that the object has a certain deformation range. In some embodiments, the deformation range of the acoustic element 100 may be from −10 mm to 0 mm. A negative deformation value refers to a difference between the size of the acoustic element 100 after being deformed and the size of the acoustic element 100 before being deformed, for example, −10 mm refers to the size of the acoustic element 100 after being deformed is 10 mm less than the size of the acoustic element 100 before being deformed. By this deformation range, the entire structure of the acoustic element 100 can be soft and elastic, similar to a sponge that can be deformed within a certain range when subjected to force, thereby enhancing wearing comfort and adaptability. In addition, the deformable acoustic element 100 is also conducive to improving adaptability, that is, the standard acoustic element 100 of the same model can be adapted to the user's ear canal of different sizes within a certain range, and the acoustic element 100 can be closely attached to the ear canal without any gap, which facilitates the fixation of the acoustic element 100. In addition, the deformable acoustic element 100 can also be resistant to structural damage when compressed, thereby extending the service life of the acoustic element 100. Compared with the hard acoustic element 100, the deformable acoustic element 100 can reduce the discomfort of the user during long-term wearing, sleeping or chewing and improve the wearing comfort.

In addition, since the acoustic element 100 of the embodiment of the present disclosure can be compressed within a relatively large deformation range while ensuring permeability to avoid the occlusion effect, one type of acoustic element 100 can be adapted to the ear canal structure of most people, so that the skin of the ear canal and an outer layer of the acoustic element 100 are attached to each other without any gap. The acoustic element 100 that can currently only be customized according to the shape of the user's ear canal is simplified to several types of standardized acoustic elements 100, thereby greatly reducing the cost of the acoustic element 100. The acoustic element 100 of the embodiment of the present disclosure has high adaptability, and is particularly suitable for children whose ear canals change constantly as they grow, so that the problem that children need to frequently replace the acoustic element 100 can be avoided, and the use experience can be improved.

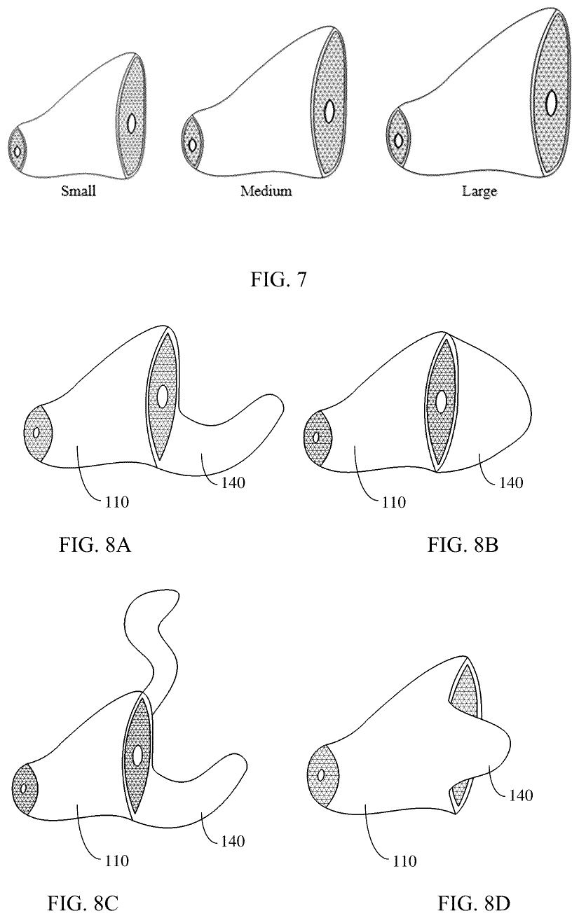

In some embodiments, the acoustic element 100 may be customized according to a personalized structure of the user's ear canal, or may be standardized according to ergonomics. For example, the standardized acoustic elements 100 of different specifications can be obtained according to the statistical characteristics of different ear canal sizes and in combination with the characteristics such as the age and gender of different groups. Referring to FIG. 7, three types of standardized acoustic elements 100 are exemplarily shown. From left to right, the sizes of the acoustic elements 100 are sequentially increased (e.g., small, medium, and large in the figure), but the shapes of the acoustic elements 100 are consistent.

The standardized acoustic element 100 can be mass-produced, so that the manufacturing cost of the acoustic element 100 due to the customized design can be reduced.

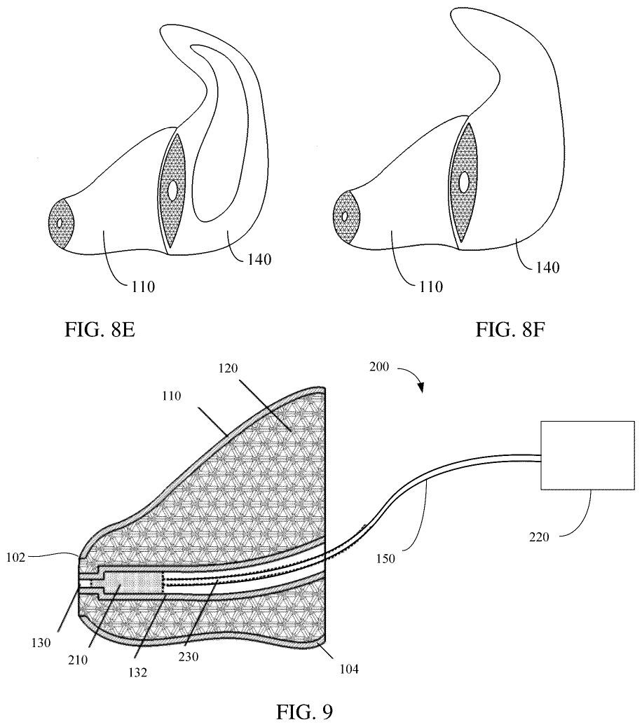

In some embodiments, referring to FIGS. 8A to 8F, the acoustic element 100 further includes a fixing structure 140 configured to fix the acoustic element 100 to the ear of the user. Specifically, the fixing structure 140 cooperates with a pinna of the user and is connected to the outer housing 110 to fix the acoustic element 100 to the ear of the user.

The fixing structure 140 and the outer housing 110 of the acoustic element 100 may be integrally formed, or may be separately formed and then connected to the outer housing 110. The material of the fixing structure 140 may be the same as the material of the outer housing 110 of the acoustic element 100, or may be another material as long as the acoustic element 100 can be fixed to the ear of the user and the material is comfortable for the user to use. The shape of the fixing structure 140 may be configured according to an actual user requirement. Only several possible examples of the fixing structure 140 are given in FIG. 7, but this does not constitute a limitation on the embodiment of the present disclosure. The acoustic element 100 is fixed on the ear of the user through the fixing structure 140, the firmness of wearing the acoustic element 100 by the user can be improved, the acoustic element 100 is prevented from being lost, and the acoustic element 100 can be easily removed and worn by the user, thereby improving the user's experience.

Referring to FIG. 9, an embodiment of the present disclosure further provides an acoustic device 200, which includes the aforementioned acoustic element 100 and the first audio device. The first audio device 210 is at least partially accommodated in the accommodating cavity 132.

In some embodiments, the acoustic device 200 further includes a second audio device 220. The second audio device 220 is communicatively connected to the first audio device 210. The second audio device 220 is configured to input an audio electrical signal or directly input a sound signal to the first audio device 210. Optionally, the second audio device 220 may be a host of a hearing aid, an audio player, or a mobile phone.

In some embodiments, the acoustic device 200 may be a hearing aid, such as a RIC (Receiver in the canal) hearing aid, a BTE hearing aid, an ITC (In the canal) hearing aid, a CIC (Complete in the canal) hearing aid, an ITE (In the ear) hearing aid, an ITE-full shell hearing aid, an ITE-half shell hearing aid, or an ITE-low shell hearing aid, etc. The RIC hearing aid includes a hearing aid host, a receiver (or a speaker), and an ear mold. The receiver (or speaker) is fixed in an ear canal through the ear mold, the hearing aid host and the receiver are connected through a wire, the wire transmits an electrical signal generated by the hearing aid host to the receiver, and the receiver converts the electrical signal into a sound signal. The BTE hearing aid includes a hearing aid host, an acoustic conduit, and an ear mold. The acoustic conduit is fixed in the ear canal through the ear mold, and the acoustic conduit transmits the sound signal generated by the hearing aid host to the ear canal.

The communication connection may be a wired connection or a wireless connection. In some embodiments, the acoustic device 200 further includes a signal communication line 150, such as a conductive line or an acoustic conduit. The second audio device 220 may be connected to the first audio device 210 through the signal communication line 150, so as to transmit audio signals such as sound or audio electrical signals.

The acoustic device 200 of the embodiment of the present disclosure includes the aforementioned acoustic element 100. Since the air inside and outside the ear canal can be circulated through the plurality of first holes 122 of the porous structure 120 in communication with each other, the pressure inside and outside the ear canal is balanced, and the occlusion effect is improved, so that no additional ventilation channel are required. In addition, the plurality of first holes 122 can absorb a part of the sound to prevent the sound from leaking to the external device and causing acoustic noise, thereby improving the wearing experience of the user.

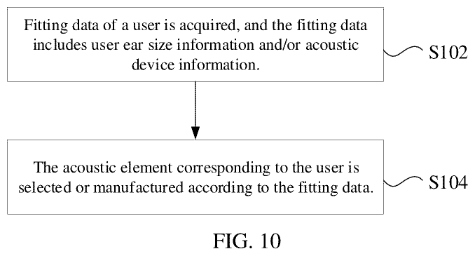

A method for manufacturing an acoustic element 100 is provided according to an embodiment of the present disclosure, and the method can be applied to the aforementioned acoustic element 100. As shown in FIG. 10, the method may include the following steps.

S102, fitting data of a user is acquired, and the fitting data includes user ear size information and/or acoustic device information.

The user ear size information may be only user ear canal critical size data, or may be user ear canal modeling data. The acoustic device information may include, for example, user audio impairment data (e.g., a user audiogram), a wearing habit, a hearing device type selected by the user, etc.

The user ear canal critical size data may include, for example, a length and a width of a first bend, a length and a width of a second bend, a distance from the second bend to first bend, a length and a width of an ear canal opening, a distance from the first bend to the ear canal opening, etc., which may be obtained in advance by measuring the user's ear canal. The user ear canal modeling data may be an ear canal model established by the critical size of the user's ear canal. The user audio impairment data may include an impairment of the user's hearing at low frequencies and an impairment of the user's hearing at high frequencies, which may be obtained by testing the user's hearing by a detection device.

S104, the acoustic element 100 corresponding to the user is selected or manufactured according to the fitting data.

In some embodiments, the appropriate acoustic element 100 may be selected from a limited number of existing standardized acoustic elements 100 according to the acquired user fitting data, for example, the acoustic element 100 that is substantially adapted to the size of the user's ear canal may be selected according to the user ear size information. Moreover, the user audio impairment data can illustrate the impairment of the user's hearing. The user's hearing is impaired more severely, the acoustic device 200 requires more power. The size of the first audio device 210 is larger, the sound emitted is louder, and the likelihood of sound leakage is increased. Correspondingly, the size of the accommodating cavity 132 of the acoustic element 100 is larger, the porosity (or an average hole diameter of the first holes 122) is smaller. In addition, a deformable or non-deformable acoustic element 100 may be selected according to the wearing habit of the user. Alternatively, the adapted acoustic element 100 may be selected depending on the type of acoustic device 200 selected by the user, e.g., whether the second end of the acoustic element 100 has a wiring channel depending on a wireless or wired connection.

In some embodiments, S104 may include first determining a plurality of size-matched standard acoustic elements 100 from a plurality of standardized acoustic elements 100 according to user ear size information, then determining a power required by the acoustic device according to the acoustic device information, and determining a power-matched target standard acoustic element 100 from the plurality of size matched standard acoustic elements 100. For example, when the power of the acoustic device 200 is large, the acoustic element 100 having a small porosity (or the average hole diameter of the first holes 122) is selected, and vice versa.

In other embodiments, the acoustic element 100 may also be customized for the user according to the acquired user fitting data so that the acoustic element 100, in particular, the shape thereof is more closely attached to the user's ear canal.

In some embodiments, S104 may include designing a contour of the acoustic element 100 corresponding to the user according to the user ear size information; determining a power required by the acoustic device 200 according to the acoustic device information, and manufacturing the acoustic element 100 corresponding to the user according to the contour and the power required by the acoustic device 200.

Similar to the aforementioned embodiments, the user's hearing is impaired more severely, the acoustic device 200 requires more power. The size of the first audio device 210 is larger, the sound emitted is louder, and the likelihood of sound leakage is increased. Correspondingly, the size of the accommodating cavity 132 of the acoustic element 100 is larger, the porosity (or the average hole diameter of the first holes 122) is smaller. The appropriate porosity (or the average hole diameter of the first holes 122) that the acoustic element 100 needs may be configured according to the power of the acoustic device 200. According to the contour and porosity of the acoustic element 100 (or the average hole diameter of the first holes 122), the acoustic element 100 suitable for the user can be manufactured by a 3D printing method.

In this embodiment, the acoustic element 100 corresponding to the user is selected or manufactured according to the acquired user fitting data, the acoustic element 100 suitable for the user can be obtained relatively quickly and accurately. Since the porous structure 120 of the acoustic element 100 can sufficiently realize the air circulation inside and outside the ear canal, and the porous structure 120 can effectively reduce the occurrence of the low acoustic noise phenomenon, it can be easier to select or manufacture the acoustic element 100 suitable for the user without additional design of the ventilation channel, and the cost of the acoustic element 100 is reduced.

It should be understood that, although the steps in the flowchart according to the embodiments described above are shown sequentially as indicated by the arrows, the steps are not necessarily sequentially performed as indicated by the arrows. Unless expressly stated herein, these steps may be performed in other sequences without strict sequence limitations. Moreover, at least a part of the steps in the flowchart according to the embodiments described above may include a plurality of steps or stages, which are not necessarily performed at the same time, but may be performed at different times. The execution order of the steps or stages is not necessarily sequential, but may be performed in turn or alternately with at least a part of other steps or stages.

The above-mentioned embodiments do not constitute a limitation on the protection scope of the technical solution. Any modifications, equivalent replacements and improvements made within the spirit and principles of the above-mentioned embodiments shall be included within the protection scope of this technical solution.

The embodiments above only represent several implementation modes of the present application, and the description thereof is relatively specific and detailed, but it should not be construed as limiting the scope of the patent. It should be noted that for those skilled in the art, various modifications and improvements may be made without departing from the concept of the present application, and all these modifications and improvements belong to the protection scope of the present application. Therefore, the scope of protection of the patent application should be subject to the appended claims.

1. An acoustic element, comprising:
a first end adapted to be located proximate to inside of an ear and a second end adapted to be located proximate to outside of the ear; and
a porous structure provided between the first end and the second end, the porous structure being provided with:
a plurality of first holes in communication with each other, wherein the first end is in communication with the second end through at least part of the first holes; and
an accommodating cavity configured to at least partially accommodate a first audio device, wherein the accommodating cavity is in communication with an external environment from the first end.

2. The acoustic element according to claim 1, wherein at least part of the plurality of first holes in communication with each other form a mesh channel, and the first end is in communication with the second end through the mesh channel.

3. The acoustic element according to claim 1, wherein the porous structure is a three-dimensional frame structure, the three-dimensional frame structure comprises a plurality of repeating units, the plurality of repeating units are arranged in an array in a three-dimensional space, and the plurality of first holes are formed between the plurality of repeating units.

4. The acoustic element according to claim 3, wherein each repeating unit comprises at least three rods respectively extend in non-coplanar directions, and ends of adjacent rods of the plurality of repeating units are connected to each other.

5. The acoustic element according to claim 4, wherein a longitudinal dimension of each rod is from 100 microns to 5 millimeters, and a transverse dimension of each rod is from 20 microns to 1 millimeter.

6. The acoustic element according to claim 3, wherein the plurality of repeating units are formed of a porous material having a plurality of second holes.

7. The acoustic element according to claim 6, wherein hole diameters of the plurality of second holes are less than or equal to 50 microns.

8. The acoustic element according to claim 1, wherein a porosity of the porous structure is less than or equal to 99%.

9. The acoustic element according to claim 1, wherein a porosity of the porous structure gradually decreases in a direction from the first end to the second end.

10. The acoustic element according to claim 1, wherein hole diameters of the plurality of first holes are from 100 microns to 5 millimeters.

11. The acoustic element according to claim 1, further comprising an outer housing, wherein the porous structure is at least partially provided in the outer housing, the housing has a first opening at the first end and a second opening at the second end, the porous structure is exposed from the first opening and the second opening.

12. The acoustic element according to claim 11, wherein the housing and/or the porous structure are elastic.

13. The acoustic element according to claim 11, wherein a size of at least a portion of the housing is adapted to a user's ear canal.

14. The acoustic element according to claim 11, further comprising a fixing structure, wherein the fixing structure cooperates with a pinna of a user and is connected to the housing to fix the acoustic element to the ear of the user.

15. The acoustic element according to claim 1, wherein the porous structure is further provided with an acoustic hole, the acoustic hole is provided between the accommodating cavity and the first end, and the accommodating cavity is in communication with the external environment through the acoustic hole.

16. The acoustic element according to claim 1, wherein the acoustic element is an intra-aural ear mold.

17. An acoustic device, comprising an acoustic element according to claim 1 and a first audio device being at least partially accommodated in an accommodating cavity.

18. The acoustic device according to claim 17, further comprising a second audio device communicatively connected to the first audio device.

19. The acoustic device according to claim 18, wherein the second audio device is a hearing aid.

20. The acoustic device according to claim 17, wherein the second audio device communicates with the first audio device though a wireless network or a signal line.

21-23. (canceled)
